(19) United States
(12) Patent Application Publication
(10) Pub. No.: US 2003/0009544 A1
(43) Pub. Date: Jan. 9, 2003

(54) Method of performing distributed load testing

(76) Inventor: Raymond S. Wach, Hopkinton, MA (US)

Correspondence Address: DALY, CROWLEY & MOFFORD, LLP, SUITE 101, 275 TURNPIKE STREET, CANTON, MA, 02021-2310, US

(21) Appl. No.: 09/859,716

(22) Filed: May 17, 2001

Related U.S. Application Data
(60) Provisional application No. 60/209,235, filed on Jun. 5, 2000.

(51) Int. Cl. G06F 15/173

(52) U.S. Cl. 709/223

(57) ABSTRACT

The present invention provides a method of performing distributed load testing to a remote web site or software component across a network. Loads are presented to the desired web site or software component from a variety of systems located through out the world. Unlike prior systems which are limited to using commonly owned systems which are on a common intranet, the presently described method is able to utilize a variety of systems from across the world to provide loads from different parts of the world, in effect creating a worldwide community Quality Assurance lab. Utilizing systems selected from a large variety of systems located throughout the world provides a test environment that more accurately emulates a real world environment.

### CROSS REFERENCE TO RELATED APPLICATIONS

This application claims priority under 35 U.S.C. §119(e) to provisional patent application serial No. 60/209,235 filed Jun. 5, 2000; the disclosure of which is incorporated by reference herein.

### BACKGROUND OF THE INVENTION

In order to effectively exercise web sites or software components it is necessary to provide several loads to the web site or software component. A load can be thought of as a virtual user performing one or more transactions with the web site or software component. Prior methods utilize commonly owned systems which are on a common intranet to provide the desired load from various points on the network to the target web site or software component. While this presents sufficient load, it does so from the same points on the network continuously, thus access from different points of the network cannot be tested properly. In actual use the web site or software component would be accessed from a large variety of locations using different paths across the network, instead of fixed locations which may be limited to the same paths. Further, the prior art methods have required the service provider to purchase and maintain the multiple systems located across the network in order to provide the load from various locations. These systems must be purchased or leased and be maintained by the service provider, thus causing the service provider to incur considerable cost and expense. It would be desirable to provide testing from different locations on the network dynamically, to more closely emulate the real world environment the web site or software component will see when actually deployed, and to do so without incurring the expense of purchasing and maintaining multiple systems at remote locations.

### SUMMARY OF THE INVENTION

With the foregoing background in mind, it is an object of the present invention to provide a method of performing distributed load testing. Loads are presented to the desired web site or software component from a variety of systems located through out the world. Unlike prior systems which are limited to using commonly owned systems which are on a common intranet, the presently described method is able to utilize a variety of systems from across the world to provide loads from different parts of the world, in effect creating a worldwide community Quality Assurance lab. Utilizing systems selected from a large variety of systems located throughout the world provides a test environment that more accurately emulates a real world environment.

### BRIEF DESCRIPTION OF THE DRAWINGS

The invention will be better understood by reference to the following more detailed description and accompanying drawings in which:

FIG. 1 is a diagram of the system used to perform the present method.

### DETAILED DESCRIPTION

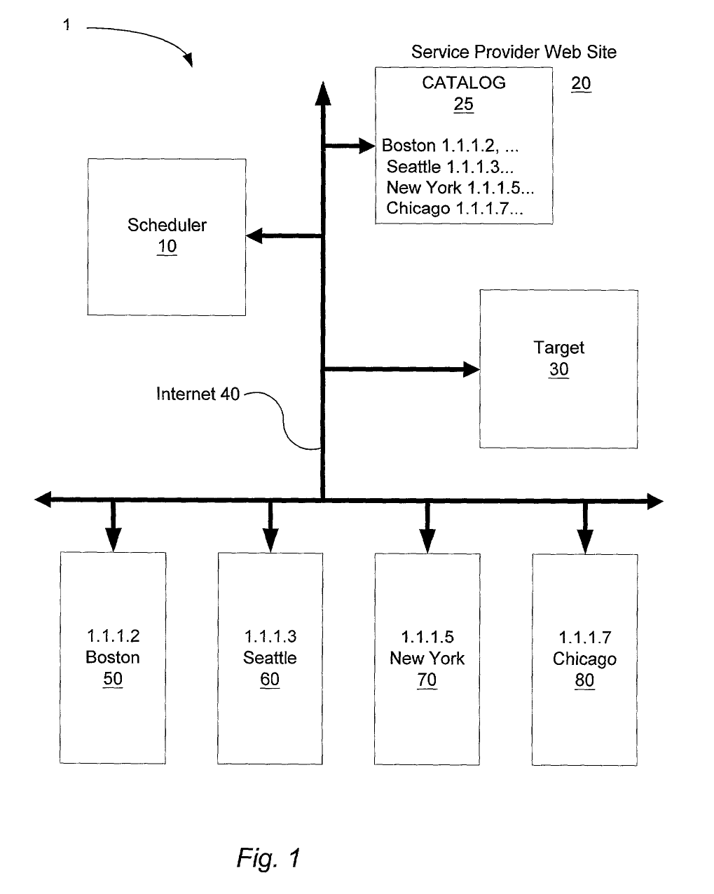

Referring to FIG. 1 a system 1 is shown by which distributed load testing is performed. In one embodiment it is desired to test a web site 30 (the target web site). The web site 30 may be load tested, that is provided with a predetermined number of virtual users which access the web site 30 across a network such as Internet 40. The virtual users perform a variety of functions or transactions with the web site 30, much as the web site would experience in a real world environment. In a preferred embodiment system owners sign up their systems to be used to generate loads during times when their system would otherwise be inactive. Systems 50, 60, 70, 80 are registered through a service-provider web site 20 to form a catalog 25 (dynamic or static) of systems that are available to provide load. The catalog 25 includes a list of entries, one entry for each registered system. The entry may include information about the characteristics of the system. This information may include the location of the system, the IP address of the system, the size or speed of the system, and the availability of the system. Other characteristics of the system may also be included. A scheduler 10 is used to schedule the desired loads, such that a request for loads from a predetermined number of systems and/or a predetermined geographical area can be provided.

In a particular example, the owner of a target web site 30 may desire that the target web site 30 be tested from 10:00 p.m. until 1:00 a.m. with load agents from systems physically located in Boston, Seattle and Chicago. While only three systems are described here, this is done for simplicity to explain the concepts of the present invention. In actual use, a large number of systems are utilized in accordance with the present invention. The load agents may be scripts available from a load test tool such as e-Load® offered by Empirix Inc. of Waltham, Mass. The scheduler 10 parses through the catalog 25 to identify systems that are available which meet the specified criteria. Having identified the appropriate systems to use to generate loads, the scheduler 10 schedules each identified system to run its load agents to the target web site 30 across Internet 40 at the appropriate time. Therefore, at 10:00 p.m., the system 50 in Boston at IP address 1.1.1.2, the system 80 in Chicago at IP address 1.1.1.3, and the system 60 in Seattle at I.P Address 1.1.1.7 run their load agents to generate a number of virtual users accessing the target web site 30 across Internet 40. In such a manner the target web site 30 is being load tested by traffic being generated from different parts of the country.

The next day, the web site owner may desire that the same tests be run from the same sites at the same time. Given the dynamic nature of the catalog, the system in Boston may be a different system than the one used the previous time. Accordingly, the loads may be coming from a different physical location through a different path of routers and switches to exercise the target web site.

Alternately, the web site owner may request that the target web site 30 be tested from 10:00 p.m. until 1:00 a.m. with load agents from systems in Boston, New York and Chicago. Again the scheduler 10 parses through the catalog 25 to identify systems that are available which meet the specified criteria. Having identified the appropriate systems to use to generate the loads, the scheduler 10 schedules each identified system to run its load agents to the target web site 30 at the appropriate time. Therefore, at 10:00 p.m., the system 50 in Boston at IP address 1.1.1.2, the system 80 in Chicago at IP address 1.1.1.3, and the system 70 in New York at I.P Address 1.1.1.5 run their load agents to generate a number of virtual users accessing the target web site 30 across Internet 40. In such a manner the target web site is being load tested by traffic being generated from different parts of the country. Again these loads are taking different paths to access the target web site, thus providing a more realistic testing environment which more closely resembles the type of traffic the target web site will experience in actual use. The loads may be deployed to a target web site which hasn't been publicly deployed yet to determine how the web site will perform when the web site is available to the public. The loads may also be deployed to a target web site which is available to the public to ensure the web site is performing as expected.

It should be noted that while only a few catalog entries were used for this explanation, this was done merely for simplicity. In use, the catalog would contain any number of available systems for providing distributed load. While load testing was described, the method could also be used for monitoring of a target web site. Monitoring is used to provide testing of deployed Web Applications in order to detect and report performance problems. Monitoring software may be e-Monitor® (available from Empirix Inc. of Waltham, Mass. The monitoring provided by the systems report failures in real time. The monitor software may provide a variety of notification options and corrective actions to allow the web site owner to quickly resolve any problems.

In an additional embodiment it is desired to test a software component. The software component may comprise an application, objects such as an Enterprise Java Bean (EJB) available from Sun Microsystems, CORBA available fro IBM, or COM, DCOM and COM+ available from Microsoft Corporation, or a collection of objects. Systems are registered through a service-provider web site to form a catalog of registered systems that are available to provide load to the component under test. The catalog includes a list of entries, one entry for each available system. The entry may include information about the characteristics of the system. This information may include the location of the system, the IP address of the system, the size of the system, and the availability of the system. Other characteristics of the system may also be included. A scheduler is used to schedule the loads, such that a request for loads from a predetermined number of systems and/or a predetermined geographical area can be provided.

In a particular example, the owner of the software component to be tested may desire that the software component be tested from 10:00 p.m. until 1:00 a.m. with load agents from Boston, Seattle and Chicago. The load agents for testing a software component may be scripts available from a software component test tool such as Bean-test™ available fro Empirix Inc. of Waltham, Mass. The scheduler parses through the catalog to identify systems that are available which meet the specified criteria. Having identified the appropriate systems to use to generate load, the scheduler schedules each identified system to run its load agents on the software component across the Internet at the appropriate time. Therefore, at 10:00 p.m., the system in Boston at IP address 1.1.1.2, the system in Chicago at IP address 1.1.1.3, and the system in Seattle at I.P Address 1.1.1.7 run their load agents to generate a number of virtual users accessing the software component. In such a manner the software component is being load tested by traffic being generated from different parts of the country.

As stated above, the ability to test a web site or software component with loads generated from systems physically located throughout the world provides testing which more closely emulates a real world environment. Additionally, the cost of implementing such a system is kept at a minimum since the service provider does not need to own and/or maintain the various systems registered with the service provider.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method of performing distributed testing of a target comprising the steps of:
identifying at least one system which meets a predetermined criteria;
scheduling said at least one system to provide load to said target;
deploying said at least one system at the scheduled time, said at least one system providing load to said target.

2. The method of claim 1 wherein said target comprises a web site.

3. The method of claim 1 wherein said target comprises a software component.

4. The method of claim 1 wherein said predetermined criteria are selected from the group comprising: locations of said systems, sizes of said systems, speeds of said systems, and availability of said systems.

5. The method of claim 1 wherein said at least one system provides load across a network to said target.

6. The method of claim 1 further including the step of defining a catalog of potential systems which meet said predetermined criteria and wherein said step of identifying at least one system is performed from said catalog of potential systems.

7. The method of claim 3 wherein said software component is selected from the group consisting of EJB, Corba, COM, DCOM and COM+.

8. The method of claim 5 wherein said network comprises the Internet.

9. The method of claim 6 wherein said catalog is dynamic.

10. The method of claim 6 wherein said catalog is static.

11. A method of performing distributed monitoring of a target comprising the steps of:
identifying at least one system which meets a predetermined criteria;
scheduling said at least one system to monitor said target; and
deploying said at least one system at the scheduled time, said system providing monitor functions to said target.

12. The method of claim 11 wherein said target comprises a web site.

13. The method of claim 11 wherein said predetermined criteria are selected from the group comprising: locations of said at least one system, sizes of said at least one system, speeds of said at least one system, and availability of said at least one system.

14. The method of claim 11 wherein said at least one system provides monitor functions across a network to said target.

15. The method of claim 1 further including the step of defining a catalog of potential system which meet said predetermined criteria and wherein said step of identifying at least one system is performed from said catalog of potential systems.

16. The method of claim 14 wherein said network comprises the Internet.

17. The method of claim 15 wherein said catalog is dynamic.

18. The method of claim 15 wherein said catalog is static.

19. A computer program product for performing distributed load testing of a target comprising a computer usable medium having computer readable code thereon, including program code which:
identifies at least one system which meets a predetermined criteria;
schedules said at least one system to provide load to said target; and
deploys said at least one system at the scheduled time, said at least one system providing load to said target.

20. The computer program product of claim 19 wherein said target comprises a web site.

21. The computer program product of claim 19 wherein said target comprises a software component.

22. The computer program product of claim 19 wherein said predetermined criteria are selected from the group comprising: locations of said at least one system, sizes of said at least one system, speeds of said at least one system, and availability of said at least one system.

23. The computer program product of claim 19 wherein said systems provide load across a network to said target.

24. The computer program product of claim 19 further comprising program code for defining a catalog of potential systems which meet said predetermined criteria and wherein said program code for identifying said at least one system is performed from said catalog of potential systems.

25. The method of claim 21 wherein said software component is selected from the group consisting of EJB, Corba, COM, DCOM, and COM+.

26. The computer program product of claim 23 wherein said network comprises the Internet.

27. The computer program product of claim 24 wherein said catalog is dynamic.

28. The computer program product of claim 24 wherein said catalog is static.

29. A computer program product for performing distributed monitoring of a target comprising computer usable medium having computer readable code thereon, including program code which:
identifies at least one system which meets a predetermined criteria;
schedules said at least one system to provide load to said target; and
deploys said at least one system at the scheduled time, said at least one system providing monitor functions to said target.

30. The computer program product of claim 29 wherein said target comprises a web site.

31. The computer program product of claim 29 wherein said target comprises a software component.

32. The computer program product of claim 18 wherein said predetermined criteria are selected from the group comprising: locations of said at least one system, sizes of said at least one system, speeds of said at least one system, and availability of said at least one system.

33. The computer program product of claim 27 further comprising program code for defining a catalog of potential systems which meet said predetermined criteria and wherein said program code for identifying said at least one system is performed from said catalog of potential systems.

34. The computer program product of claim 27 wherein said software component is selected from the group consisting of EJB, CORBA, COM, DCOM, and COM+.

35. The computer program product of claim 29 wherein said systems provide load across a network to said target.

36. The computer program product of claim 22 wherein said network comprises the Internet.
